(19) United States
(12) Patent Application Publication
(10) Pub. No.: US 2022/0297483 A1
(43) Pub. Date: Sep. 22, 2022

(54) SMOOTH BORE HUBCAP AND ROTARY UNION

(71) Applicant: Equalaire Systems, Inc., Corpus Christi, TX (US)

(72) Inventor: James Sharkey, San Antonio, TX (US)

(21) Appl. No.: 17/634,182

(22) PCT Filed: Aug. 12, 2020
(86) PCT No.: PCT/US2020/046014

§ 371 Date: Feb. 9, 2022

Related U.S. Application Data
(60) Provisional application No. 62/885,654, filed on Aug. 12, 2019.

(51) Int. Cl. B60C 23/00

(52) U.S. Cl. CPC B60C 23/00327

(57) ABSTRACT

A hubcap and rotary union, the hubcap having the outer face forming a smooth-bore at the center of the face, and a rotary union body having a smooth lug, the smooth lug being rotatably disposed in the bore.

### CROSS REFERENCE TO RELATED APPLICATION

This application claims priority to U.S. Provisional Patent Application 62/885,654 titled “Smooth Bore Hubcap and Rotary Union” filed Aug. 12, 2019, which is hereby entirely incorporated herein by reference.

### FIELD

This application relates generally to tire inflation systems and the components thereof.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

Automatic tire inflation systems (ATIS) may be used to control vehicle tire pressure by adding fluid to one or more vehicle tires as needed during vehicle operation. An automatic tire inflation system may include a rotary union generally configured to convey pressurized fluid from a vehicle-mounted fluid supply to rotating or rotatable tires. The rotary unions may, for example, be threadably mounted within a hubcap of a vehicle or a rotary union may be mounted to a hubcap using another type of connection that does not permit rotational adjustment of the rotary union to align a rotary union hose connection with a tire valve. Likewise, hubcaps may commonly be attached to a wheel hub using a connection that does not permit rotational adjustment. Accordingly, installation and maintenance of ATIS systems may commonly involve over-tightening or under-tightening a rotary union connection to a hubcap increasing risk of damage to the rotary union and associated ATIS components.

There is a need for a rotary union that allows for ready positioning of a hose connection with respect to a tire valve.

### SUMMARY

A rotary union comprising a rotor body having a first end and a second end, the first end comprising a cylindrical lug having a smooth outer surface configured to freely rotate in a hubcap having a smooth bore configured to receive the cylindrical lug, the rotor body forming a fluid channel extending from the first end to a surface of the body. The rotary union further comprising a tubular member having a first end sealingly disposed in the fluid channel at the first end of the rotor body.

A hubcap comprising a cylindrical body having a first end and a second end, the first end being enclosed by an outer face, the outer face having a cylindrical orifice formed at the center of the face, the orifice comprising a smooth bore; the second end comprising threads configured for threaded engagement with a vehicle hub.

A rotary union comprising a body having a first end and a second end, the first end comprising a smooth lug, the lug having a groove formed circumferentially around the outer diameter of the lug; the body forming a fluid channel extending from the first end to a surface of the body; and a tubular member having a first end sealingly disposed in the fluid channel at the first end of the body.

A hubcap and rotary union comprising a cylindrical hubcap body having a first end and a second end, the first end being enclosed by an outer face, the outer face forming an orifice at the center of the face, the orifice having a smooth bore, the second end comprising threads configured for threaded engagement with a vehicle hub; and a rotary union body having a first end and a second end, the first end comprising a smooth lug, the lug having a groove formed circumferentially around the outer diameter of the lug, the body forming a fluid channel extending from the first end to a surface of the body; a tubular member having a first end sealingly disposed in the fluid channel at the first end of the body; the smooth lug being rotatably disposed in the orifice, and a retaining ring disposed in the groove so as to retain the lug in the orifice.

A method of assembling a rotary union and a hubcap, the method comprising providing a rotary union body having a first end and a second end, the first end comprising a smooth lug, the lug having a groove formed circumferentially around the outer diameter of the lug, the body forming a fluid channel extending from the first end to a surface of the body, the rotary union body having a tubular member having a first end sealingly disposed in the fluid channel at the first end of the body; disposing a retaining ring in the groove; providing a hubcap comprising a cylindrical hubcap body having a first end and a second end, the first end being enclosed by an outer face, the outer face forming an orifice at the center of the face, the orifice having a smooth bore, the second end comprising threads configured for threaded engagement with a vehicle hub; compressing the retaining ring in the groove and inserting the lug and retaining ring into the smooth bore at the outer face; and translating the lug and retaining ring through the smooth bore until the retaining ring emerges from the smooth bore and expands, the lug being thus rotatable disposed in the smooth bore.

A combined hubcap and rotary union comprising a hubcap having an outer face and a smooth-bore orifice formed at the center of the outer face; and a rotary union body having a smooth lug, the lug having a groove formed circumferentially around an outer diameter of the lug, the smooth lug being rotatably disposed in the orifice, and a retaining ring disposed in the groove so as to retain the lug in the orifice.

### BRIEF DESCRIPTION OF THE DRAWINGS

FIG. 1 is a perspective view of a heavy vehicle having a tire inflation system.

FIG. 2 illustrates a semi-exploded section view of a hubcap and rotary union.

FIG. 3 illustrates a hubcap with a rotary union mounted thereon.

FIG. 4 illustrates a hubcap with a rotary union mounted thereon and showing a vent shield.

FIG. 5A shows a rotor body including a deformable end including serrations.

FIG. 5B shows a rotor body including a deformable end including a barb.

FIG. 5C shows a rotor body including a deformable end mounted to a hubcap.

### DETAILED DESCRIPTION

This disclosure is generally related to rotary unions and automatic tire inflation systems including rotary unions. A rotary union may be disposed so as to help convey pressurized fluid from a vehicle-mounted fluid supply to rotating or rotatable tires. For example, a rotary union may be mounted in a hubcap and include components for communicating fluid from a pressurized vehicles axle to a hose connection providing sealed fluid communication with a tire valve of a rotatable tire. Rotary unions as described herein may include a rotor body including a cylindrical lug having a smooth outer surface configured to rotate in a hubcap bore. The rotor body may be securely retained within the hubcap yet rotatable with respect to the hubcap so that an outlet port of the rotor body may be aligned with the tire valve of a tire. Accordingly, hoses used for routing fluid from the rotary union to the tire valve may be more easily connected without stressing the rotary union or hose tubing. Advantageously, this may simplify installation of rotary unions and prevent inadvertent damage to inflation system components during installation or maintenance.

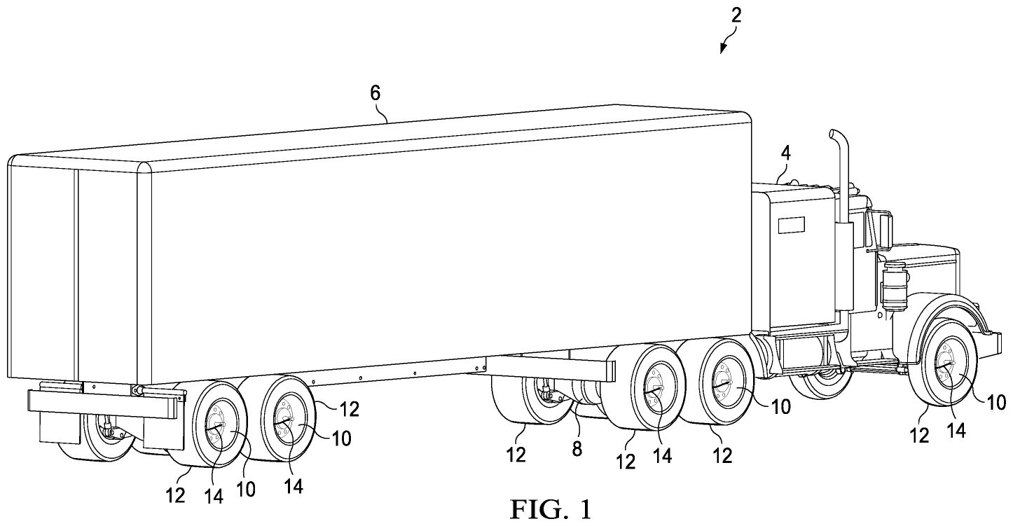

A rotary union configured for mounting within and freely rotating in a hubcap bore may be included in a commercial truck or other vehicle, such as shown in FIG. 1. As shown therein, a vehicle 2 may comprise a truck 4 and a trailer 6. The truck 4 may include one or more drive axles 8 as part of the vehicle's powertrain. The truck 4 may further include a steer axle (not shown in detail) having pivotable spindles that may provide steering capability for the vehicle 2. The trailer 6 may include one or more fixed axles (not shown). Each axle may have one or more wheels 10 mounted thereto. A pneumatic tire 12 may be mounted to each wheel 10.

The vehicle 2 may be provided with an automatic tire inflation system that may use pressurized air from the vehicle's air brake system or some other source of pressurized air to maintain the tires at a desired air pressure. For example, pressurized air may be directed along or through an axle and routed to a rotary union mounted in the hubcap. A rotary union may communicate fluid to one or more air hoses 14. The hoses 14 may communicate fluid to and from the tires 12. The tire 12 may, for example, be a standard single tire or a wide-base tire, such as a super-single tire, as used in commercial vehicles.

An automatic tire inflation system may further include other components, including, for example, a pressure regulator (not shown). A pressure regulator may, for example, be mounted in a sealed control box including an electronic control board and processor suitable for controlling the pressure regulator. The pressure regulator may receive pressurized fluid from a fluid pressure source, such as a vehicle air brake system air supply or a step-up or booster pump, and control the pressure of fluid from the fluid pressure source so as to provide fluid pressure at a level suitable for inflating the tires, such as, for example, a fluid pressure of 110 psi. Pressurized fluid may flow from the pressure regulator through a conduit to the axles. From there, the fluid may flow through conduit fluid lines in or along the axle, or through the axle (if sealed) to a rotary union disposed within a hubcap.

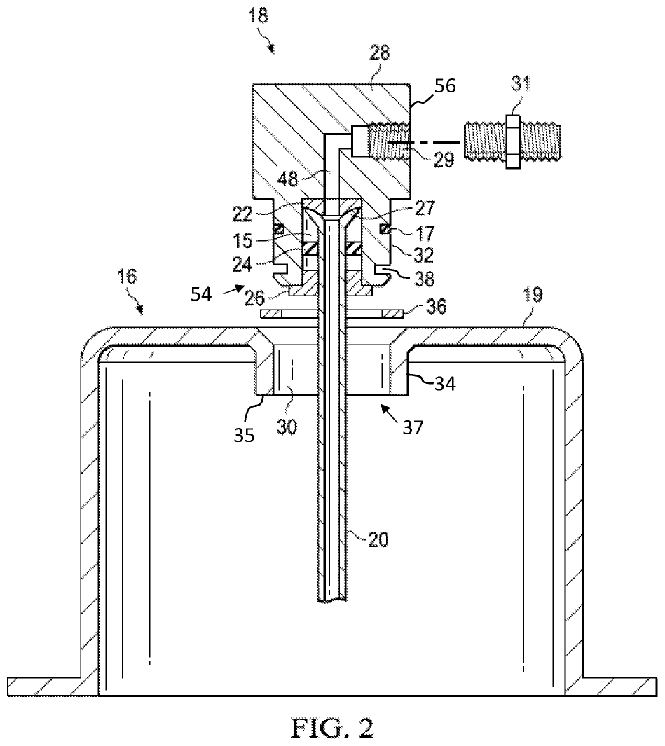

An embodiment of a rotary union configured for rotatable mounting within a hubcap bore is shown in FIG. 2. As shown therein, a rotary union 18 may include a rotor body 28 having a tubular member 20 rotatably sealed therein. The tubular member 20 may have one end 27 sealingly disposed in a fluid channel 48 of the rotor body 28 at a first end 54 of the rotor body 28. The fluid channel 48 may extend from the first end 54 to an outer surface 56 of the rotor body 28. An outlet port 29 may be disposed at the outer surface 56 so as to provide fluid communication to a connecting hose 14 (shown in FIG. 1). Thus, pressurized fluid may be provided from the tubular member 20 through fluid channel 48 to the outlet port 29 for communication to a vehicle tire. In some embodiments, an annular seal 24 may be disposed about the tubular member 20 so as to seal the tubular member 20 to the rotor body 28 and to prevent fluid from escaping from the fluid channel 48 into the hubcap 16. The annular seals 24 may, for example, comprise an o-ring, washer, lip seal, face seal, or any other suitable sealing interface. The seal 24 may comprise a variety of materials, such as rubber, silicone, graphite, and steel or any other suitable sealing material or interface. In the embodiment shown in FIG. 2, a bearing 22 may be disposed at the end 27 of the tubular member 20 in the rotor body 28. A telescope cap 26 may be used to retain the tubular member 20, bearing 22, and annular seal 24 in the rotor body 28.

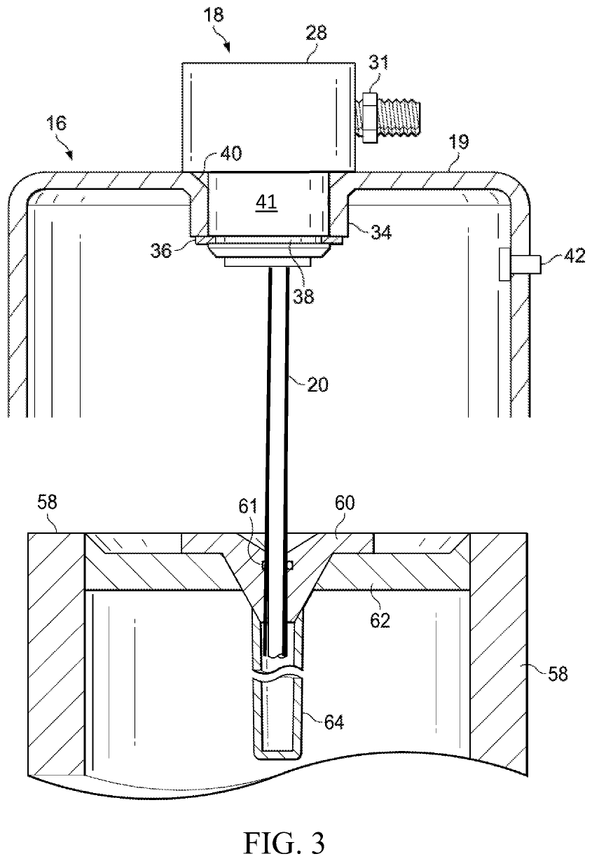

With further reference to FIG. 3, the rotor body 28 may include a lug 32 extension including a cylindrical body 41 with a smooth outer surface. The lug 32 may be received within a central bore 30 of the hubcap 16. The central bore 30 may define a cylindrical opening within an outer face 19 of the hubcap 16. Walls of the central bore 30 may be directed inwardly towards the hubcap interior to form a hubcap central boss 34. The hubcap central boss 34 may include a free end 35 generally defining boss face 37, the free end 35 and boss face 37 facing the hubcap interior.

As shown in FIG. 3, rotary union 18 may be mounted to the hubcap 16 by inserting the lug 32 into the central bore 30 and hubcap central boss 34. As shown therein, a retaining ring 36 may further be disposed within a groove 38 formed on a surface of the lug 32. The retaining ring 36 may have an inner diameter and an outer diameter defining a ring width, the circumferential groove sized to receive a retaining ring 36 having the ring width when the retaining ring 36 is compressed. For example, the retaining ring 36 may be compressed and disposed within the groove 38 before the lug 32 is inserted through the central bore 30. In other embodiments, the retaining ring 36 may be disposed within the groove 38 after the lug 32 is inserted within the central bore 30. Still in other embodiments, the retaining ring 36 may be aligned adjacent to the rotor body 28 prior to insertion within the central bore 30. The retaining ring 36 may be compressed while inserting of the rotor body 28 through the central bore 30 and become seated with the groove 38 during the insertion. The retaining ring 36 may be disposed in the groove 38 so as to help retain the rotor body 28 in the smooth bore. For example, the retaining ring 36 may firmly fit within the groove 38 upon compression. However, the ring 36 may expand to a size such that translation of the rotary union 18 out of the central bore 30 is prevented.

The rotor body 28 may be rotatably mounted within the central bore 30. For example, lug 32 may include a cylindrical body 41 with a smooth outer surface. The hubcap central boss 34 may have a corresponding smooth inner surface. The interface between the lug 32 and the hubcap central boss 34 may provide suitably low friction to allow for rotation. Accordingly, the rotor body 28 may be rotated with respect to the hubcap when a user applies a manual level of torque. Thus, the position of an outlet port 29 and/or hose connection device 31 may be readily aligned with a tire valve.

In some embodiments, an annular seal 17 may be disposed at the hubcap-rotary union interface. Such a seal 17 may be an O-ring, lip seal or any other suitable seal configuration, and may comprise a variety of materials, such as rubber, silicone, nylon, oilite or graphite. The seal 17 may provide some friction between the lug and the central bore 30 but may still allow the rotor body 28 to rotate in the central bore 30. The seal 17 may further be used to provide contaminant ingress protection and to provide a seal against lubricant leakage from the hubcap interior.

In some embodiments, as seen in FIG. 3, the walls of the orifice 30 may have a gradual lead 40 to said walls, such as a bevel or chamfer, taper, or curvature. Such a lead 40 may allow said retaining ring to be installed at the mating lug 32 prior to installing the rotary union 18 into the hubcap 16. The lead 40 would allow an uncompressed retaining ring 36 to be seated into the annular groove 38 of the mating lug 32 and the lead of the orifice walls would compress said retaining ring such that the leading edge of the mating lug may then pass through the bore of the orifice. Upon passing through and exiting the orifice bore, the retaining ring 36 may decompress or expand to the original size and thus lock the rotary union to the hubcap.

As further shown in FIG. 3, in some embodiments, tubular member 20 may be coaxially extendable and translatably disposed in an axle 58. For example, one end of tubular member 20 may sealably engage an annular seal 61 disposed in the stator 60. The stator 60 may, for example, couple to a press plug 62 which is in turn sealingly disposed at an open end of the axle 58. An air filter 64 may further be disposed at an end of the stator 60. Alternatively, in other embodiments, annular seal 61 may be directly disposed in the axle 58. The first annular seal 61 may be a rotating or non-rotating seal and provide a pivotable or non-pivotable sealing engagement with the tubular member 20. For example, the tubular member 20 may be pivotably and translatably disposed in the first annular seal 61 to accommodate wheel runout. In other words, depending on the configuration of the annular seal 61, the tubular member 20 may or may not rotate in the seal 61.

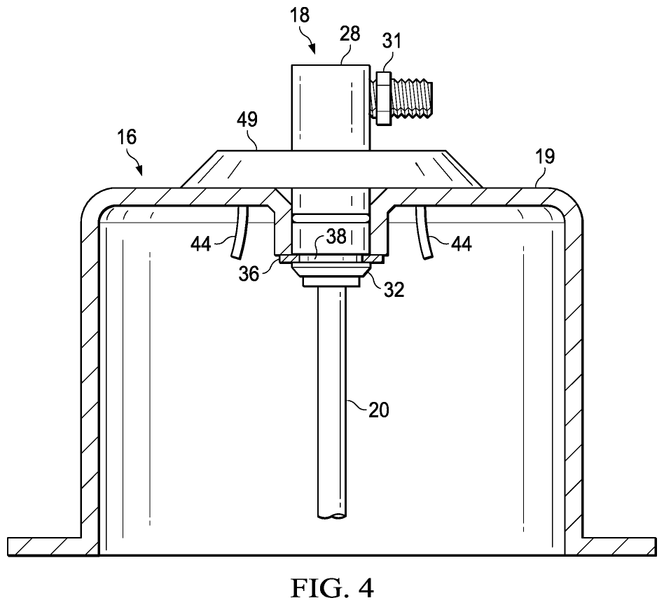

In some embodiments, a pressure relief valve 42 may also be installed in a wall or face of the hubcap 16 so as to vent an excess pressure event from the interior of the hubcap. Such a relief valve could be a one-way valve such as a duckbill valve, non-return valve, ball check valve, or other style of check valve wherein materials are only allowed to pass from the interior of the hubcap to the exterior of the hubcap. Such an excess pressure event may be initiated through a leak of the tire inflation components, overheating, or other events that may increase the pressure of the interior of a hubcap. In such an embodiment, it is not necessary to shield the vent to prevent contaminants from entering through the vent and the fit at the hubcap-rotary union interface may be of a close tolerance to attenuate the possible ingress of contaminants at said interface. However, a vent shield 49 as seen in FIG. 4 may be added as an optional configuration when there may be concern the hubcap-rotary union interface would provide an ingress path for contaminants.

In other embodiments, as seen in FIG. 4, pressure in the interior of the hubcap may be released by means of one or more vents 44 disposed adjacent to the central bore 30. The vents 44 allow pressure in the hubcap 16 to be released to atmosphere. The vents 44 may comprise an open tube that is curved so that lubricant may be flung from the end of the tube by centrifugal force when the hubcap 16 rotates with the tire as the vehicle is traveling on a road. The vent shield 49 is disposed over the vents 44 to prevent contaminants from entering the hubcap interior. A flapper disk (not shown) may be disposed between the vent shield 49 and the vent tubes so as to substantially seal the vents 44. As fluid is released from the hubcap, the flapper disk may flutter away from the hubcap so as to allow the pressurized fluid to escape. For highly-pressurized hubcaps, the fluid flowing from the vents to atmosphere may cause the flapper disk to flutter with sufficient violence to cause a loud noise, thus permitting a driver to detect the wheel end having the pressurized hubcap more readily.

In some embodiments, rotor body 28 may include a lug 32 comprising one or more grooves running axially along the lug 32. The grooves may further provide a flow path for venting of excess pressure. In some embodiments, such as for rotary unions used on hubcaps with non-liquid lubricant, the annular seal may be omitted to better allow pressurized gases to escape the hubcap. Addition of such grooves may better permit venting of pressurized gases.

Some embodiments may include a vent shield 49, the shield 49 may then cover hubcap vents so as to prevent contaminants from entering the hubcap 16 through the vents 44. For embodiments where the shield 49 does not protect a vent, the shield may still be included so as to prevent contaminants ingress at the hubcap-rotary union interface.

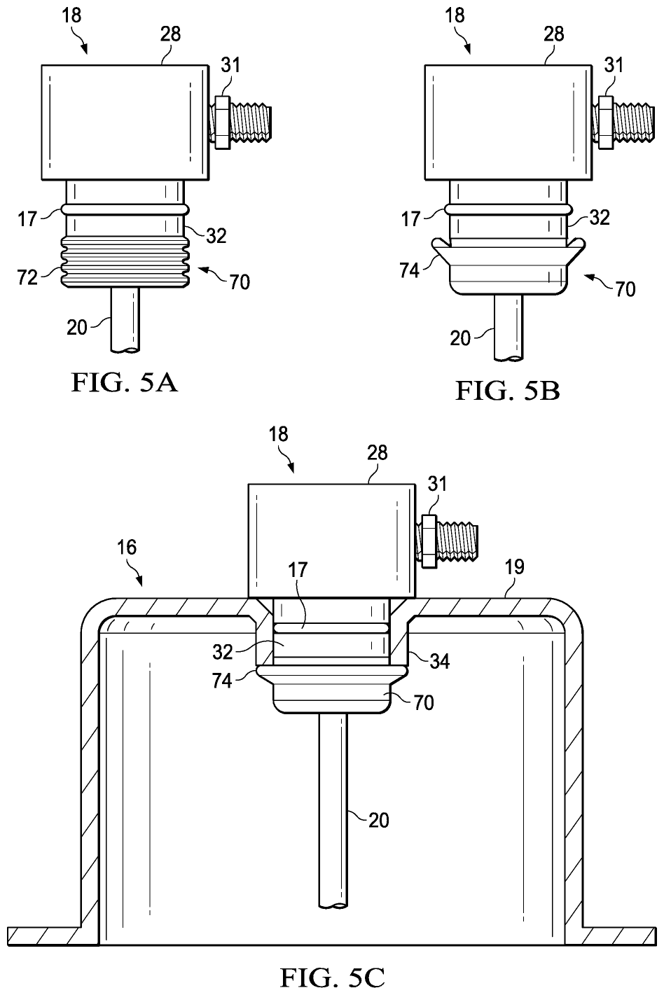

In some embodiments, rotary union 18 may be shaped so that it may be inserted within the central bore 30 and held within the hubcap central boss 34, including without using a retaining ring 36. For example, as shown in each of FIGS. 5A-5C a lug 32 may include a deformable end 70, the deformable end 70 may be designed to adopt a compressed, folded, or otherwise altered shape suitable for insertion within the bore 30. Once the end 70 is at least partially inserted through the bore 30, it may adopt a shape suitable to retain the rotor body 28 in the hubcap central boss 34. Deformable end 70 may, for example, comprise an elastic or rubber skirt generally disposed at the end 54 of the rotor body 28. In some embodiments, a deformable end 70 may comprise a material (e.g., a shape-memory polymer) that may adopt a shape that is temperature dependent. For example, a deformable end 70 may readily contract and hold a first shape at one temperature, such as an ambient temperature at which the rotary union 18 may be installed within a hubcap 16. The deformable end 70 may adopt a second shape under another temperature condition, such as an elevated temperature condition as may be applied when setting a rotary union 18 in place within central bore 30. A deformable end 70 may comprise a material that may set under elevated temperature conditions typically found within a rotating tire. In some embodiments, a deformable end 70 may comprise a material that may adopt a shape that is temperature dependent. For example, deformable end 70 may comprise a material that adopts a significantly expanded shape under elevated temperature conditions.

As shown in FIG. 5A, a rotor body 28 may comprise a lug 32 including a deformable end 70 with a plurality of serrations 72. When passing through the central bore 30 the serrations 72 may become compressed. Upon passing through the central bore 30 the serrations 72 may expand such as to substantially match their original shape prior to insertion or to adopt another suitable shape useful for gripping a wall of the hubcap central boss 34 thereby preventing inadvertent translation of the rotor body 28 out of the central bore 30. As shown in FIG. 5B, a lug 32 may include a deformable end 70 including one or more barbs 74. A barb 74 may be configured so that it folded inwards when inserted within central bore 30 and configured to adopt a different shape when inserted through the central bore 30. For example, the barbs 74 may be configured to adopt a shape wherein the barbs 74 abut free end 35 of the hubcap central boss 34 such that translation of the rotor body 28 out of the central bore 30 is prevented. For example, as shown in FIG. 5C, barb 74 may contact free end 35 to prevent inadvertent translation of the rotor body 28 out of the central bore 30.

Although the disclosed subject matter and its advantages have been described in detail, it should be understood that various changes, substitutions and alterations can be made herein without departing from the subject matter as defined by the appended claims. Moreover, the scope of the present application is not intended to be limited to the particular embodiments of the process, machine, manufacture, composition, or matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. For example, although the disclosed apparatus, systems and methods may be described with reference to a manual or manually-activated pressure reduction valve, an electric valve or other automatic electronic or mechanical valve may be used to accomplish relatively rapid reduction of fluid pressure. Accordingly, the appended claims are intended to include within their scope such processes, machines, manufacture, compositions of matter, means, methods, systems or steps.

What is claimed is:

1. A rotary union comprising:
a rotor body having a first end and a second end, the first end comprising a cylindrical lug having a smooth outer surface configured to freely rotate in a hubcap having a smooth bore configured to receive the cylindrical lug, the rotor body forming a fluid channel extending from the first end to a surface of the body; and
a tubular member having a first end sealingly disposed in the fluid channel at the first end of the rotor body.

2. The rotary union of claim 1, the cylindrical lug comprising a circumferential groove having an annular seal disposed therein, the annular seal being configured to seal the cylindrical lug to the hubcap when the cylindrical lug is disposed in the smooth bore.

3. The rotary union of claim 1, the cylindrical lug comprising a circumferential groove configured to receive a retaining ring.

4. The rotary union of claim 3, the cylindrical lug having the retaining ring disposed in the circumferential groove; and
the retaining ring having an inner diameter and an outer diameter defining a ring width, the circumferential groove configured to receive the ring width when the retaining ring is compressed.

5. The rotary union of claim 1, the cylindrical lug further comprising a deformable end, the deformable end configured to adopt a compressed, folded, or otherwise altered shape during insertion of the cylindrical lug.

6. The rotary union of claim 5 wherein said deformable end comprises a shape-memory polymer. The rotary union of claim 5 wherein said deformable end comprises an elastic or rubber material.

8. The rotary union of claim 5 wherein said deformable end comprises a serration or a barb.

9. A method of mounting a rotary union to a hubcap, the method comprising:
providing a rotary union comprising a cylindrical lug having a smooth outer surface;
providing a hubcap comprising an outer face, the outer face having a smooth bore formed therein; and
disposing the cylindrical lug in the smooth bore.

10. The method of claim 9, further comprising retaining the cylindrical lug in the smooth bore so as to prevent free translation of the cylindrical lug out of the smooth bore.

11. The method of claim 10, wherein the retaining comprises disposing a retaining ring about the cylindrical lug at an interior of the hubcap.

12. The method of claim 10, wherein the retaining comprises disposing a deformable end of said cylindrical lug at an interior of the hubcap.

13. The method of claim 12, where the deformable end comprises a serration or a barb.

14. The rotary union of claim 1, further comprising an annular seal sealing the tubular member to the rotor body, the tubular member being rotatable with respect to the rotor body.

15. The rotary union of claim 1, further comprising a bearing disposed between the first end of the tubular member and the rotor body.

16. The rotary union of claim 1, the first end of the tubular member being flared.

17. The rotary union of claim 1, further comprising a telescope cap disposed in the fluid channel about the tubular member so as to retain the first end of the tubular member in the rotor body.

18. The rotary union of claim 1, further comprising a graphite bearing non-rotatably disposed in the fluid channel at the first end of the tubular member, the first end of the tubular member and a graphite bearing forming a rotary face seal, the tubular member being rotatable with respect to the body.

19. A hubcap comprising:
a cylindrical body having a first end and a second end, the first end being enclosed by an outer face, the outer face having a smooth bore formed at a center of the outer face, the smooth bore being configured to receive a smooth lug of a rotary union.

20. The hubcap of claim 19, wherein the smooth bore and the outer face meet at a transitional edge, the transitional edge comprising a radius, a taper or a chamfer.

21. The hubcap of claim 19, wherein the smooth bore comprises a face end disposed at the outer face, the smooth bore extending into the interior of the cylindrical body and terminating at a free end, the smooth bore being tapered from the face end toward the free end.

22. A hubcap and rotary union assembly comprising:
a cylindrical hubcap body having an outer face, the outer face forming a smooth bore at the center of the face; and
a rotary union comprising:
a rotor body having a first end and a second end, the first end comprising a cylindrical lug having a smooth outer surface, the rotor body forming a fluid channel extending from the first end to a surface of the body; and
a tubular member having a first end sealingly disposed in the fluid channel at the first end of the body;
wherein the cylindrical lug is rotatably disposed in the smooth bore of the hubcap.

23. The hubcap and rotary union assembly of claim 22 further comprising an annular seal disposed between the cylindrical lug and the smooth bore.

24. The hubcap and rotary union assembly of claim 22 further comprising an annular seal disposed between the rotary body and the hubcap body.

25. The hubcap and rotary union assembly of claim 22, further comprising a retaining ring disposed about the cylindrical lug at an interior of the hubcap so as to prevent free translation of the cylindrical lug out of the smooth bore.

26. The hubcap and rotary union assembly of claim 22, the cylindrical lug further comprising a deformable end, the deformable end configured to adopt a compressed, folded, or otherwise altered shape during insertion of the lug.

27. The hubcap and rotary union assembly of claim of claim 26 wherein said deformable end comprises a shape-memory polymer.

28. The hubcap and rotary union assembly of claim of claim 26 wherein said deformable end comprises an elastic or rubber material.

29. The hubcap and rotary union assembly of claim of claim 26 wherein said deformable end comprises a serration or a barb.

30. The hubcap and rotary union assembly of claim 22, wherein the smooth bore and the outer face meet at a transitional edge, the transitional edge comprising a radius or chamfer configured to permit insertion of the cylindrical lug into the bore while a retaining ring is disposed in the groove.

31. The hubcap and rotary union of claim 22, wherein the smooth bore comprises a face end disposed at the outer face, the smooth bore extending into the interior of the cylindrical body and terminating at a free end, the smooth bore being tapered from the face end toward the free end, the taper being configured to permit insertion of lug into the bore while the retaining ring is disposed in the groove.

32. A method of assembling a rotary union and a hubcap, the method comprising:
providing a rotary union body having a first end and a second end, the first end comprising a smooth lug, the lug having a groove formed circumferentially around the outer diameter of the lug, the body forming a fluid channel extending from the first end to a surface of the body, the rotary union body having a tubular member having a first end sealingly disposed in the fluid channel at the first end of the body;
disposing a retaining ring in the groove;
providing a hubcap comprising a cylindrical hubcap body having an outer face, the outer face forming a smooth bore at the center of the fac;
compressing the retaining ring in the groove and inserting the lug and retaining ring into the smooth bore at the outer face; and
translating the lug and retaining ring through the smooth bore until the retaining ring emerges from the smooth bore and expands, the lug being thus rotatable disposed in the smooth bore.

33. The method of claim 32, wherein the smooth bore and the outer face meet at a transitional edge, the transitional edge comprising a radius or chamfer configured to permit insertion of lug into the smooth bore while the retaining ring is uncompressed and to permit compression of the retaining ring as the lug translations through the smooth bore.

34. The hubcap of claim 19, wherein the smooth bore comprises a face end disposed at the outer face, the smooth bore extending into the interior of the cylindrical body and terminating at a free end, the smooth bore being tapered from the face end toward the free end, the taper being configured to permit insertion of lug into the smooth bore while the retaining ring is uncompressed and to permit compression of the retaining ring as the lug translations through the smooth bore.

35. A combined hubcap and rotary union comprising a hubcap having an outer face and a smooth bore formed at the center of the outer face; and a rotary union body having a smooth lug, the smooth lug being rotatably disposed in the smooth bore.

36. The combined hubcap and rotary union of claim 35, the smooth lug comprising a circumferential groove; and a retaining ring disposed in the groove so as to retain the lug in the smooth bore.
